(19) United States
(12) Patent Application Publication
(10) Pub. No.: US 2009/0115762 A1
(43) Pub. Date: May 7, 2009

(54) PLASMA DISPLAY DEVICE AND METHOD OF DRIVING THE SAME

(76) Inventor: Woo-Joon Chung, Suwon-si (KR)

Correspondence Address: CHRISTIE, PARKER & HALE, LLP, PO BOX 7068, PASADENA, CA, 91109-7068, US

(21) Appl. No.: 12/249,810

(22) Filed: Oct. 10, 2008

(30) Foreign Application Priority Data
Nov. 1, 2007 (KR) 10-2007-00110997

(51) Int. Cl. G09G 3/28; G09G 5/00; G06F 3/038

(52) U.S. Cl. 345/211; 345/60; 345/67

(57) ABSTRACT

A plasma display device and a method of driving the same. Embodiments of the present invention provide a plasma display device and a method of driving the same with a reduced number of power supplies and improved performance. During a reset period, a voltage that gradually increases to two times as much as the sustain voltage is applied to a scan electrode, the sustain electrode is electrically floated during a period of the reset period when the voltage of the scan electrode is gradually decreased. A reference voltage is applied to a plurality of scan electrodes to which a scan voltage is not applied during an address period, as a non-scan voltage.

### CROSS-REFERENCE TO RELATED APPLICATION

This application claims priority to and the benefit of Korean Patent Application No. 10-2007-0110997 filed in the Korean Intellectual Property Office on Nov. 1, 2007, the entire content of which is incorporated herein by reference.

### BACKGROUND OF THE INVENTION

1. Field of the Invention

The present invention relates to a plasma display device and a method of driving the same.

2. Description of the Related Art

Plasma display devices are flat panel displays that display characters or images using plasma generated by gas discharge. A display panel of a plasma display device includes hundreds of thousands to millions of discharge cells (hereinafter referred to as “cells”) or more, which are arranged in a matrix, according to the size of the plasma display panel.

The plasma display device divides one frame of an image into a plurality of subfields, and each of the subfields has a weight value to drive the plasma display device. The luminance of the cells is determined by the total value of the weight values of subfields in which the cells emit light, among the plurality of subfields.

Further, each subfield includes a reset period, an address period and a sustain period. The reset period is a period when the state of the wall charges of the cells return to an initial state, and the address period is a period for selecting light emitting cells and non-light emitting cells. The sustain period is a period when the cells that are selected to emit light during the address period sustain-discharge during a period corresponding to the weight value of the subfield to display images.

FIG. 1 illustrates driving waveforms of a typical plasma display device. In FIG. 1, driving waveforms are applied to a scan electrode, a sustain electrode and an address electrode corresponding to a single cell.

As shown in FIG. 1, while a voltage of the address electrode (indicated as A in FIG. 1) and a voltage of the sustain electrode (indicated as X in FIG. 1) are maintained as a reference voltage (indicated as 0 V in FIG. 1, and referred to as 0V voltage hereinafter) during a rising period of a reset period, a voltage of the scan electrode (indicated as Y in FIG. 1) is gradually increased to a voltage (indicated by Vs+Vset in FIG. 1, and referred to as Vs+Vset voltage hereinafter) at which all of the cells are discharged.

Thereafter, while the voltage of the address electrode and the voltage of the sustain electrode are maintained at the 0V voltage and a bias voltage (indicated as Ve in FIG. 1 and referred to as Ve voltage hereinafter) during a falling period of the reset period, respectively, the voltage of the scan electrode is gradually decreased to a voltage (indicated as Vnf in FIG. 1 and referred to as Vnf voltage hereinafter) at which the wall voltage between the sustain electrode and the scan electrode becomes 0V.

Next, while the voltage of the sustain electrode is maintained at the Ve voltage during the address period, the scan voltage (indicated as VscL in FIG. 1, and referred to as VscL voltage hereinafter) is applied to the scan electrode, and an address voltage (indicated as Va in FIG. 1 and referred to as Va voltage hereinafter) is applied to the address electrode of a cell selected as a light emitting cell among cells configured by the scan electrode to which the scan voltage is applied.

Further, during a sustain period, the sustain voltage (indicated as Vs in FIG. 1 and referred to as Vs voltage hereinafter) and the 0V voltage are alternately applied to the scan electrode and the sustain electrode such that sustain discharges occur in the cell selected in the address period.

As described above, in order to apply the driving waveform shown in FIG. 1 to the scan electrode, the sustain electrode, and the address electrode, the plasma display device should include power supplies that supply the Vs voltage, the Vset voltage, the Vnf voltage, the VscL voltage, the VscH voltage, the Ve voltage, and the Va voltage. Therefore, as the number of power supplies is increased, the manufacturing cost is accordingly increased.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Embodiments of the present invention provide a plasma display device and a method of driving the plasma display device that can reduce the number of power supplies that supply driving voltages.

An exemplary embodiment of the present invention provides a method of driving a plasma display device that includes a plurality of first electrodes, a plurality of second electrodes extending in the same direction as the plurality of the first electrodes, a plurality of third electrodes crossing the first electrodes and the second electrodes, and a plurality of discharge cells formed by adjacent first electrodes, second electrodes, and third electrodes. A voltage of the plurality of the second electrodes is gradually decreased to a second voltage while a first voltage is applied to a plurality of first electrodes during a first period of a reset period. The voltage of the plurality of the second electrodes is gradually decreased to a third voltage that is lower than the second voltage while the plurality of first electrodes are electrically floated during a second period of the reset period. During an address period, while the first voltage is applied to the plurality of first electrodes, a fourth voltage lower than the third voltage is sequentially applied to the plurality of second electrodes, and a fifth voltage that is at least equal to a ground voltage is applied to the remaining second electrodes to which the fourth voltage is not applied, among the plurality of second electrodes. During a sustain period, the first voltage and a sixth voltage lower than the first voltage are alternately applied to the plurality of first electrodes and the plurality of second electrodes.

During the address period, a seventh voltage may be applied to a third electrode among the third electrodes corresponding to a discharge cell to be selected among the discharge cells. The discharge cell corresponds to a second electrode among the second electrodes to which the fourth voltage is applied. The seventh voltage may be lower than a voltage difference between the fifth voltage and the fourth voltage.

The method may further include, during a third period prior to the first period of the reset period, gradually increasing the voltage of the plurality of second electrodes from an eight voltage to a ninth voltage.

The voltage difference between the eighth voltage and the ninth voltage may correspond to the eighth voltage.

Further, a level of the first voltage may be substantially the same as a level of the eighth voltage.

At a finishing point of the second period of the reset period, a seventh voltage that is lower than the first voltage may be applied to the plurality of first electrodes, and a voltage difference between the third voltage and the seventh voltage may correspond to a voltage at which discharges are fired between the plurality of first electrodes and the plurality of second electrodes.

The fifth voltage may be a ground voltage or a voltage that operates a switch included in a driving circuit that applies driving voltages to the plurality of first electrodes, the plurality of second electrodes, and the plurality of third electrodes.

Another embodiment according to the present invention provides a plasma display device including a plasma display panel and a driving board. The plasma display panel includes a plurality of first electrodes, a plurality of second electrodes extending in the same direction as the plurality of the first electrodes, a plurality of third electrodes crossing the first electrodes and the second electrodes, and a plurality of discharge cells at crossing of adjacent first electrodes, second electrodes and third electrodes. The driving board is configured to apply a driving voltage to the plurality of first electrodes and the plurality of second electrodes. The driving board may be configured to apply a third voltage to the plurality of second electrodes while a voltage waveform that gradually decreases from a first voltage to a second voltage is applied to the plurality of first electrodes during a falling period of the reset period. Then, during a period of the falling period in which the voltage waveform continues to decrease and become the second voltage, the driving board is configured to electrically float the plurality of second electrodes. Further, during an address period, the driving board is configured to sequentially apply a fourth voltage lower than the second voltage to the plurality of first electrodes, and apply a fifth voltage to at least one of the second electrodes to which the fourth voltage is not applied. The fifth voltage is at least equal to the ground voltage and lower than a voltage that operates switches included in the driving board.

Further, during a sustain period, the driving board may be configured to alternately apply a third voltage and a sixth voltage that is lower than the third voltage to the plurality of first electrodes and the plurality of second electrodes. Here, the sixth voltage may be a ground voltage.

During the address period, while the fourth voltage is applied to the first electrodes, the driving board may be configured to apply a sixth voltage that is lower than a voltage difference between the fifth voltage and the fourth voltage to a third electrode among the third electrodes corresponding to a discharge cell to be selected among the plurality of discharge cells. The discharge cell corresponds to a first electrode among the first electrodes to which the fourth voltage is applied.

During the reset period, the driving board may be configured to apply a voltage waveform that gradually increases from the first voltage to a sixth voltage to the plurality of first electrodes before applying the voltage waveform that gradually decreases from the first voltage to the second voltage. The sixth voltage may be two times as much as the first voltage.

At the finishing point of the reset period, a voltage of the plurality of second electrodes may be a sixth voltage that is lower than the first voltage, and the voltage difference between the sixth voltage and the second voltage is a voltage at which discharge is fired between the plurality of first electrodes and the plurality of second electrodes.

### BRIEF DESCRIPTION OF THE DRAWINGS

FIG. 1 is a drawing illustrating driving waveforms of a typical plasma display device.

FIG. 2 is a block diagram illustrating a plasma display device according to an exemplary embodiment of the present invention.

FIG. 3 is a drawing illustrating driving waveforms of a plasma display device according to a first exemplary embodiment of the present invention.

FIG. 4 is a drawing illustrating a state of wall charges at the finishing point of a reset period of the driving waveforms of FIG. 3 according to the first exemplary embodiment of the present invention.

FIG. 5 is a drawing illustrating driving waveforms of a plasma display device according to a second exemplary embodiment of the present invention.

FIG. 6 is a drawing illustrating a state of wall charges at the finishing point of a reset period of the driving waveform of FIG. 5 according to the second exemplary embodiment of the present invention.

FIG. 7 is a drawing illustrating driving waveforms of a plasma display device according to a third exemplary embodiment of the present invention.

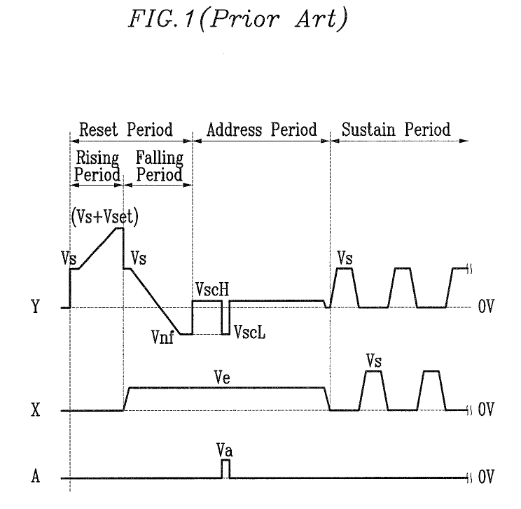

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

Throughout this specification and the claims that follow, the “wall charge” to be stored in the electrode refers to a charge that is formed on a wall (for example, dielectric layer) of a discharge cell close to the electrodes. Even though the wall charge is not actually in contact with the electrode, hereinafter, it may be described that the wall charge is formed, accumulated, or stacked on the electrode. Further, the “wall voltage” refers to a potential difference generated on the wall of the discharge cell by the wall charge.

Hereinafter, a plasma display device and a driving method thereof according to exemplary embodiments of the present invention will be described in detail with reference to the accompanying drawings.

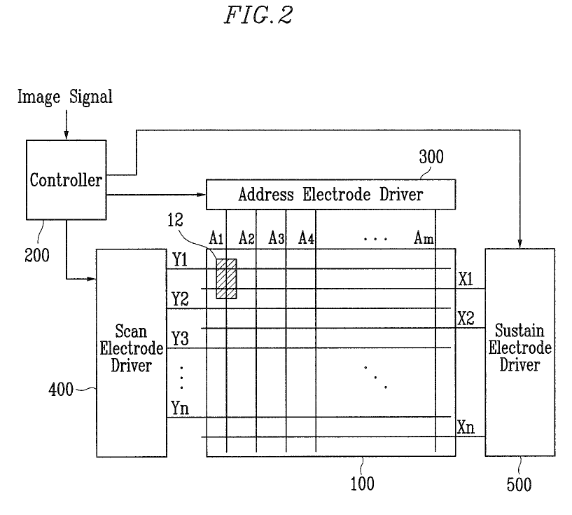

FIG. 2 is a block diagram illustrating a plasma display device according to an exemplary embodiment of the present invention.

As shown in FIG. 2, the plasma display device according to the exemplary embodiment of the present invention includes a plasma display panel (PDP) 100, a controller 200, an address electrode driver 300, a scan electrode driver 400 and a sustain electrode driver 500. The PDP 100 includes a plurality of address electrodes A1 to Am (hereinafter, referred to as “A electrodes”) extending in a column direction, and a plurality of sustain electrodes X1 to Xn (hereinafter, referred to as “X electrodes”) and a plurality of scan electrodes Y1 to Yn (hereinafter, referred to as “Y electrodes”) extending in a row direction. The plurality of Y electrodes Y1 to Yn and X electrodes X1 to Xn are arranged so as to correspond to each other. Discharge cells 12 are formed at crossing regions of the Y electrodes Y1 to Yn and X electrodes X1 to Xn and the A electrodes A1 to Am.

The controller 200 receives a video signal (e.g., an image signal) from an outside source and outputs an address electrode driving control signal, a sustain electrode driving control signal, and a scan electrode driving control signal to the address electrode driver 300, the scan electrode driver 400, and the sustain electrode driver 500, respectively. Further, the controller 200 divides one frame of an image into a plurality of subfields each having a weight value.

The address electrode driver 300 receives the address electrode driving control signal from the controller 200 to apply a signal for selecting a desired discharge cell to the A electrodes A1 to Am. The scan electrode driver 400 receives the scan electrode driving control signal from the controller 200 to apply a driving voltage to the Y electrodes Y1 to Yn, and the sustain electrode driver 500 receives the sustain electrode driving control signal from the controller 200 to apply the driving voltage to the X electrodes X1 to Xn.

Next, driving waveforms of the plasma display device according to exemplary embodiments of the present invention will be described. Hereinafter, driving waveforms that are applied to a Y electrode, an X electrode and an A electrode forming a single cell will be described for convenience sake.

FIG. 3 is a drawing illustrating a driving waveform of the plasma display device according to an exemplary embodiment of the present invention.

In FIG. 3, two adjacent subfields among a plurality of subfields into which one frame is divided are shown, and the two adjacent subfields are referred to as a first subfield SF1 and a second subfield SF2 for convenience sake. A reset period R of the first subfield SF1 is configured to include a main reset period and a reset period R of the second subfield SF2 is configured to include an auxiliary reset period. Here, the main reset period includes a reset rising period Rr and a reset falling period Rf, and reset discharges that return the state of the wall charges in all cells to an initial state occur during the main reset period. Further, the auxiliary reset period includes only the reset falling period Rf, and during the auxiliary reset period, the reset discharge occurs only in a cell that is sustain discharged in the previous subfield.

As shown in FIG. 3, while the voltage of the A electrode and the voltage of the X electrode are maintained at a reference voltage (0V in FIG. 3) during a rising period Rr of the reset period R of the first subfield SF1, the voltage of the Y electrode is gradually increased from a predetermined voltage (e.g., Vs in FIG. 3 and referred to as rising start voltage) to a voltage (e.g., Vs+Vs in FIG. 3 and referred to as maximum reset voltage) at which all of the discharge cells are discharged regardless of the wall charges of the cells. As described above, while the voltage of the Y electrode is gradually increased in the rising period Rr, weak discharge (hereinafter, referred to as reset discharge) occurs between the Y electrode and the X electrode, and between the Y electrode and the A electrode to form a negative wall charge on the Y electrode and a positive wall charge on the X electrode and A electrode.

Further, while the voltage of the A electrode and the voltage of the X electrode are maintained at a reference voltage (e.g., 0V in FIG. 3) and the voltage of the X electrode is maintained at the bias voltage (e.g., Vs in FIG. 3) during a falling period Rf of the reset period R of the first subfield SF1, the voltage of the Y electrode is gradually decreased from a predetermined voltage (e.g., Vs in FIG. 3 and referred to as falling start voltage) to a voltage (e.g., Vnf in FIG. 3 and referred to as minimum reset voltage) at which the wall voltage between the X electrode and the Y electrode becomes substantially 0 V. As described above, while the voltage of the Y electrode is gradually decreased during the falling period Rf, reset discharge occurs between the Y electrode and the X electrode, and between the Y electrode and the A electrode to erase the negative wall charge generated on the Y electrode and the positive wall charge generated on the X electrode and the A electrode.

During the address period A, in order to select a cell to be turned on, scan voltages (indicated by VscL in FIG. 3) are sequentially applied to the plurality of Y electrodes while the bias voltage (e.g., Vs in FIG. 3) is applied to the X electrode. Here, an address voltage (e.g., Va in FIG. 3) is applied to the A electrode that corresponds to a discharge cell to be selected among the plurality of discharge cells in which a scan voltage is applied to the Y electrode. Accordingly, an address discharge occurs between the A electrode to which the address voltage is applied and the Y electrode to which the scan voltage is applied, and between the Y electrode to which the scan voltage is applied and the X electrode to which the bias voltage is applied, to form the positive wall charge on the Y electrode and the negative wall charge on the A electrode and the X electrode. Here, a non-scan voltage (e.g., 0V in FIG. 3) that is higher than the scan voltage is applied to the Y electrode to which the scan voltage is not applied, and the reference voltage (e.g., 0V in FIG. 3) is applied to the A electrode of the non-selected discharge cells.

Next, during the sustain period S, a sustain voltage (e.g., Vs in FIG. 3) and the reference voltage are alternately applied to the Y electrode and the X electrode to cause the sustain discharges between the Y electrode and the X electrode. Thereafter, the process of applying the sustain discharge pulses of the sustain voltage to the Y electrode and the process of applying the sustain discharge pulses of the sustain voltage to the X electrode are repeated a number of times corresponding to the weight value of the subfield. Here, the sustain voltage may be set to a voltage level that is lower than the discharge firing voltage of the Y electrode and the X electrode.

A reset period R of the second subfield SF2 is configured to include the auxiliary reset period.

As shown in FIG. 3, during the reset period R of the second subfield SF2, while the bias voltage (e.g., Vs in FIG. 3) and the reference voltage (e.g., 0V in FIG. 3) are applied to the X electrode and the A electrode, respectively, the voltage of the Y electrode is gradually decreased from the falling start voltage (e.g., Vs in FIG. 3) to the minimum reset voltage (e.g., Vnf in FIG. 3). By doing so, while the voltage of the Y electrode is gradually decreased, reset discharge is generated between the Y electrode and the X electrode and between the Y electrode and the A electrode only in a cell that is sustain-discharged during the sustain period of the first subfield SF1, so that the wall charges formed on the electrodes are erased.

Since the address period A and the sustain period S of the second subfield SF2 are the same or similar to the address period A and the sustain period S of the first subfield SF1, the detailed description will be omitted.

Next, voltage levels of the maximum reset voltage, the minimum reset voltage, the scan voltage, the sustain voltage, the bias voltage, and the address voltage of the driving waveforms according to the first exemplary embodiment will be described.

The maximum reset voltage meets the condition expressed by the following Equation 1.

(Vset+(Vs or dVscH))+Vxy>2*Vfxy Equation 1

In Equation 1, (Vs or dVscH) refers to the rising start voltage. That is, the rising start voltage may be the Vs voltage that is used as a sustain voltage or set to the dVscH that is a voltage difference between the non-scan voltage and the scan voltage. Further, (Vset+(Vs or dVscH)) refers to the maximum reset voltage. That is, the maximum reset voltage is the sum of the rising start voltage and the Vset voltage. Vxy refers to the difference between the bias voltage that is applied to the X electrode at the finishing point of the reset period and the minimum reset voltage that is applied to the Y electrode. Vfxy (hereinafter, referred to as X-Y discharge firing voltage) is defined as a voltage at which a discharge is fired between the X electrode and the Y electrode voltage.

As represented in Equation 1, the sum of the maximum reset voltage and the Vxy voltage is set to be higher than two times as much as the X-Y discharge firing voltage. With this configuration, reset discharges can be generated in all of the cells, regardless of the wall charge state of the cells.

The address voltage meets the condition expressed by the following Equation 2.

dVscH>Va Equation 2

In Equation 2, dVscH is defined as the voltage difference between the non-scan voltage and the scan voltage, and Va is defined as the address voltage. As represented in Equation 2, the address voltage is set to be smaller than the voltage difference between the non-scan voltage and the scan voltage. With this configuration, it is possible to prevent the misfiring or low discharge during the address period.

Further, the sustain voltage meet the condition expressed by the following Equation 3.

Vs<Vfxy Equation 3

In Equation 3, Vs is defined as the sustain voltage. As represented in Equation 3, the sustain voltage is set to be smaller than the X-Y discharge firing voltage, and the sustain discharge is generated by the sustain voltage only in a cell in which wall voltage is formed between the X electrode and the Y electrode by the address discharge.

Finally, the minimum reset voltage meet the condition expressed by the following Equation 4.

Vxy=Vfxy±α Equation 4

In Equation 4, α is defined as an error range. As represented in Equation 4, at the finishing point of the reset period, the voltage difference Vxy between the voltage that is applied to the Y electrode and the voltage that is applied to the X electrode is set to be around the X-Y discharge firing voltage. With this configuration, the wall voltage between the Y electrode and the X electrode at the finishing point of the reset period becomes almost 0 V, and as a result, the misfiring or low discharge can be prevented or reduced from being generated during the address period and the sustain period.

According to the first exemplary embodiment, in order to reduce the number of power supplies that supply the voltages, the bias voltage is set to have the same level as the sustain voltage, and the non-scan voltage is set to the reference voltage. Further, the maximum reset voltage is set to have two times as much as the level of the sustain voltage. Here, for example, since the maximum reset voltage can be generated from a capacitor that is charged to the sustain voltage and a power supply that supplies the sustain voltage, and the method of generating the maximum reset voltage is well known to a person of an ordinary skill in the art, the detailed description thereof will be omitted.

Next, an exemplary plasma display device in which the X-Y discharge firing voltage is 225 V and dVscH is 120V will be used to illustrate the setting of voltages according to the first exemplary embodiment.

According to Equation 3, since the sustain voltage is set to be smaller than the X-Y discharge firing voltage, the sustain voltage may be set to 175 V.

Further, according to the first exemplary embodiment, since the maximum reset voltage is two times as much as the sustain voltage, the maximum reset voltage may be 350 V. At the finishing point of the reset period, since the voltage difference Vxy between the voltage that is applied to the Y electrode and the voltage that is applied to the X electrode is set to be around the X-Y discharge firing voltage, Equation 1 is satisfied as illustrated in the following Equation 5.

(175+175)+225>2*225 Equation 5

According to Equation 2, since the address voltage is set to be lower than the voltage difference dVscH between the non-scan voltage and the scan voltage, the address voltage may be set to 70 V. Further, according to the first exemplary embodiment, since the non-scan voltage is set to 0 V and dVscH is 120 V, the scan voltage may be set to −120 V.

As described above, according to the first exemplary embodiment of the present invention, the maximum reset voltage is set to be two times as much as the level of the sustain voltage to be generated by the power supply that supplies the sustain voltage and charges the capacitor to the sustain voltage. Further, the non-scan voltage may be generated by a power supply that supplies the reference voltage, and the bias voltage may be generated by a power supply that supplies the sustain voltage. Therefore, a separate power supply that generates the maximum reset voltage, a power supply for supplying the non-scan voltage, and a power supply for supplying the bias voltage may be omitted.

Meanwhile, according to the first exemplary embodiment, the bias voltage is set to have the same level as the sustain voltage, and the minimum reset voltage is set to have the same level as the scan voltage in order to reduce the number of power supplies.

Therefore, as represented in the following Equation 6, Equation 4 is not satisfied.

Vxy=Vs−VscL=175−(−120)=295≠225=Vfxy Equation 6

That is, according to the first exemplary embodiment, at the finishing point of the reset period, since Vxy is higher than the X-Y discharge firing voltage, the wall voltage between the X electrode and the Y electrode is not set to 0 V.

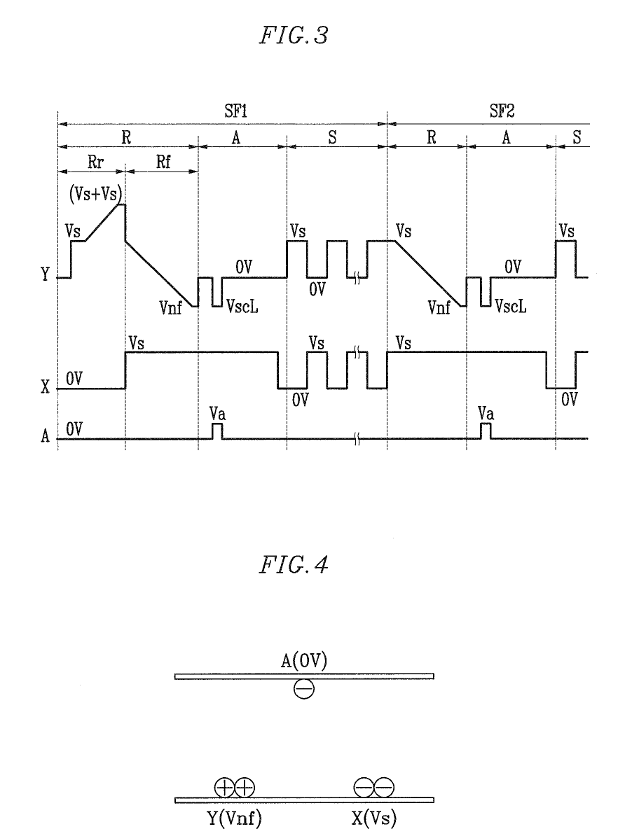

FIG. 4 illustrates a state of the wall charge at the finishing point of a reset period of the driving waveforms of FIG. 3 according to the first exemplary embodiment of the present invention.

According to the first embodiment, since Vxy is higher than the X-Y discharge firing voltage, as shown in FIG. 4, at the finishing point of the reset period R, the wall voltage between the X electrode and the Y electrode is not 0 V, a positive wall charge is formed in the Y electrode and a negative wall charge is formed in the X electrode.

During the address period A, in order to generate an address discharge for selecting a light emitting cell, a negative scan voltage is applied to the Y electrode and a positive address voltage is applied to the A electrode. However, as shown in FIG. 4, in a cell in which the negative wall charge is formed in the X electrode and the positive wall charge is formed in the Y electrode, even though the address voltage and the scan voltage are applied to the A electrode and the Y electrode, respectively, insufficient address discharge may occur or a small amount of wall charge may be formed between the X electrode and the Y electrode. Therefore, misfiring or low discharge may be generated during the sustain period.

Therefore, hereinafter, driving waveforms of the plasma display device that is capable of satisfactorily initializing the wall charge at the finishing point of the reset period will be described.

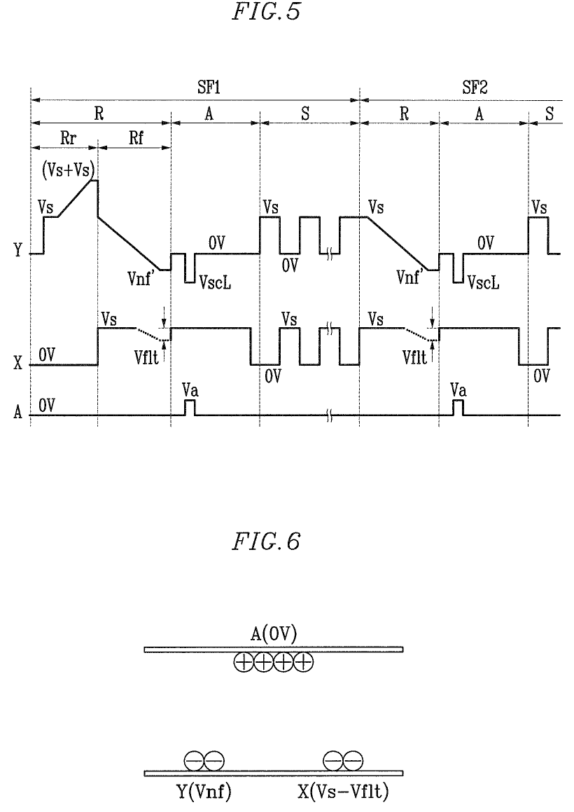

FIG. 5 illustrates driving waveforms of a plasma display device according to a second exemplary embodiment of the present invention, and FIG. 6 illustrates a state of a wall charge at the finishing point of a reset period of the driving waveforms of FIG. 5 according to the second exemplary embodiment of the present invention.

According to the second exemplary embodiment of the present invention, during a predetermined period (e.g., a period during a reset period) including the finishing point of the falling period Rf, the X electrode is floated, and the minimum reset voltage (e.g., Vnf′) is set to be higher than the scan voltage (e.g., VscL) to appropriately erase the wall charge formed between the X electrode and the Y electrode. The second exemplary embodiment is the same as the first exemplary embodiment shown in FIG. 3, except that the X electrode is floated during the predetermined period of the falling period Rf, and the minimum reset voltage is set to be higher than the scan voltage. Therefore, repeated description of FIG. 5 will be omitted.

According to the second exemplary embodiment, as shown in FIG. 5, during a falling period Rf of the reset period R, while the voltage of the A electrode is maintained at a reference voltage (e.g., 0V in FIG. 5) and the voltage of the X electrode is maintained at a bias voltage (e.g., Vs in FIG. 5), the voltage of the Y electrode is gradually decreased from a falling start voltage (e.g., Vs in FIG. 5). Thereafter, while the voltage of the X electrode is floated, the voltage of the Y electrode continues to decrease gradually to the minimum reset voltage (e.g., Vnf in FIG. 5).

Here, while the X electrode is floated, the voltage of the X electrode is gradually decreased as the voltage of the Y electrode is decreased. Therefore, at the finishing point of the falling period Rf, the voltage of the X electrode is lower than the bias voltage by a predetermined voltage (e.g., Vflt in FIG. 5).

Further, the minimum reset voltage (e.g., Vnf′ in FIG. 5) is set to be higher than the scan voltage (e.g., VscL in FIG. 5). In this case, if a circuit element such as a Zener diode for increasing a voltage is added between a power supply that supplies the scan voltage and the Y electrode, there is no need to provide an additional power supply for supplying the minimum reset voltage. Since the method of generating the minimum reset voltage that is higher than the scan voltage by using a power supply for supplying the scan voltage and the separate circuit element for increasing the voltage is well known to a person of an ordinary skill in the art, the detailed description thereof will be omitted.

As described above, according to the second exemplary embodiment, at the finishing point of the reset period, the voltage difference Vxy between the voltage that is applied to the X electrode and the voltage that is applied to the Y electrode is determined by the following Equation 7.

Vxy=(Vs−Vflt)−Vnf′=(Vs−Vflt)−(VscL+dV) Equation 7

As represented in Equation 7, at the finishing point of the reset period, the voltage that is applied to the X electrode is Vs−Vflt voltage, the voltage that is applied to the Y electrode is Vnf′ voltage, and the Vnf′ voltage is VscL+dV voltage. Here, the Vs voltage refers to the voltage level of the bias voltage, and the Vflt voltage refers to a voltage level that is decreased from the bias voltage by floating the X electrode. The VscL voltage refers to the voltage level of the scan voltage, and the dV refers to the voltage difference between the scan voltage (e.g., VscL) and the minimum reset voltage (e.g., Vnf′).

Next, an exemplary plasma display device in which the X-Y discharge firing voltage is 225V and dVscH is 120V, is used as an example to illustrate the setting of the voltages according to the second exemplary embodiment.

In the second exemplary embodiment, since the sustain voltage of 175V is the same as that of the first exemplary embodiment, the maximum reset voltage is 350 V, the address voltage is 70 V, the non-scan voltage is 0 V, the scan voltage is 120 V, and the bias voltage is 175 V which is the same as the sustain voltage, the detailed description will be omitted.

Further, according to the second exemplary embodiment, the minimum reset voltage is set to be higher than the scan voltage by a dV voltage, and the voltage of the X electrode is lower than the bias voltage by a Vflt voltage because the X electrode is floated during a period (e.g., a predetermined period) of the reset period including the finishing point. According to one embodiment, the minimum reset voltage is generated by a power supply that supplies the scan voltage and a voltage generator that generates the dV voltage, and thus a separate power supply for generating the minimum reset voltage may be omitted.

Therefore, according to the second exemplary embodiment, as represented by the following Equation 8, Equation 5 may be satisfied by Vflt and dV.

Vxy=(175−Vflt)−(−120+dV)=295−(Vflt+dV)=225 Equation 8

That is, as represented in Equation 8, when the sum of Vflt and dV is 70 V, Equation 5 may be not established. Here, the Vflt becomes higher as the time of floating the X electrode is extended, and the dV is variable by the voltage generator connected between the power supply that supplies the scan voltage and the Y electrode.

As described above, according to the second exemplary embodiment, if Vxy is set to be around the X-Y discharge firing voltage, the wall voltage between the Y electrode and the X electrode at the finishing point of the reset period becomes almost 0 V, as shown in FIG. 6. Therefore, the wall charge of the cells may be appropriately initialized. Therefore, it is possible to prevent or reduce the misfiring or low discharge during the address period and the sustain period thereafter.

Next, without providing an additional power supply for supplying the non-scan voltage, driving waveforms that the non-scan voltage is higher than the reference voltage will be described.

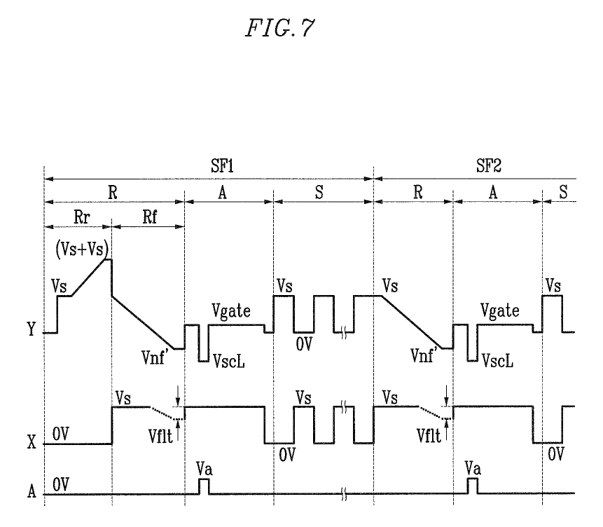

FIG. 7 illustrates driving waveforms of a plasma display device according to a third exemplary embodiment of the present invention.

According to the third exemplary embodiment, as shown in FIG. 7, the non-scan voltage is set to be a positive voltage (e.g., Vgate in FIG. 7). Since FIG. 7 is the same as FIG. 5 except that the non-scan voltage is set to a positive voltage, the repeated description of FIG. 7 will be omitted.

According to the third exemplary embodiment, by setting the non-scan voltage to be a positive voltage of 20 V or less, it is possible to increase the voltage level of the scan voltage. In this case, the voltage that is used as the non-scan voltage is set to a gate driving voltage for determining the turn-on or turn-off operation of the switch included in drivers for applying a driving voltage to the electrodes. Therefore, a separate power source for supplying the non-scan voltage can be omitted.

According to the embodiments of the present invention, with the reduced number of power supplies, the driver may have a simple configuration and the misfiring or low discharge can be prevented or reduced during the address period and the sustain period.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of driving a plasma display device comprising a plurality of first electrodes, a plurality of second electrodes extending in the same direction as the plurality of first electrodes, a plurality of third electrodes crossing the first electrodes and the second electrodes, and a plurality of discharge cells formed by the plurality of first electrodes, the plurality of second electrodes, and the plurality of third electrodes, the method comprising:
gradually decreasing a voltage of the plurality of second electrodes to a second voltage while a first voltage is applied to the plurality of first electrodes during a first period of a reset period;
gradually decreasing the voltage of the plurality of second electrodes to a third voltage that is lower than the second voltage while the plurality of first electrodes are electrically floated during a second period of the reset period;
during an address period, while the first voltage is applied to the plurality of first electrodes, sequentially applying a fourth voltage that is lower than the third voltage to the plurality of second electrodes, and applying a fifth voltage that is greater than or equal to a ground voltage to the remaining second electrodes to which the fourth voltage is not applied, among the plurality of second electrodes; and
during a sustain period, alternately applying the first voltage and a sixth voltage that is lower than the first voltage to the plurality of first electrodes and the plurality of second electrodes.

2. The method of claim 1, further comprising:
during the address period, applying a seventh voltage to a third electrode among the plurality of third electrodes corresponding to a discharge cell to be selected among the discharge cells while the fourth voltage is applied to a corresponding one of the second electrodes,
wherein the seventh voltage is lower than a voltage difference between the fifth voltage and the fourth voltage.

3. The method of claim 1, further comprising:
during a third period prior to the first period of the reset period,
gradually increasing the voltage of the plurality of second electrodes from an eight voltage to a ninth voltage.

4. The method of claim 3, wherein the voltage difference between the eighth voltage and the ninth voltage corresponds to the eighth voltage.

5. The method of claim 4, wherein a level of the first voltage is substantially the same as a level of the eighth voltage.

6. The method of claim 1, wherein at a finishing point of the second period of the reset period, a seventh voltage that is lower than the first voltage is applied to the plurality of first electrodes, and
a voltage difference between the third voltage and the seventh voltage corresponds to a voltage at which discharges are fired between the plurality of first electrodes and the plurality of second electrodes.

7. The method of claim 1, wherein the fifth voltage is a ground voltage.

8. The method of claim 1, wherein the fifth voltage is a voltage for operating a switch included in a driving circuit that applies driving voltages to the plurality of first electrodes, the plurality of second electrodes, and the plurality of third electrodes.

9. A plasma display device comprising:
a plasma display panel comprising a plurality of first electrodes, a plurality of second electrodes extending in the same direction as the plurality of first electrodes, a plurality of third electrodes crossing the first electrodes and the second electrodes, and a plurality of discharge cells at crossing regions of the plurality of first electrodes, the plurality of second electrodes and the plurality of third electrodes; and
a driving board for applying a driving voltage to the plurality of first electrodes and the plurality of second electrodes,
wherein the driving board is configured to apply a third voltage to the plurality of second electrodes while a voltage waveform that gradually decreases from a first voltage toward a second voltage is applied to the plurality of first electrodes during a falling period of the reset period, and to electrically float the plurality of second electrodes during a period of the falling period in which the voltage waveform continues to decrease to the second voltage, and
during an address period, the driving board is configured to apply sequentially a fourth voltage that is lower than the second voltage to the plurality of first electrodes, and to apply a fifth voltage to at least one of the second electrodes to which the fourth voltage is not applied, and
the fifth voltage is greater than or equal to a ground voltage and lesser than or equal to a voltage for operating switches included in the driving board.

10. The plasma display device of claim 9, wherein during a sustain period, the driving board is configured to alternately apply the third voltage and a sixth voltage that is lower than the third voltage to the plurality of first electrodes and the plurality of second electrodes.

11. The plasma display device of claim 10, wherein the sixth voltage is a ground voltage.

12. The plasma display device of claim 9, wherein during the address period, while the fourth voltage is applied to the first electrodes, the driving board is configured to apply a sixth voltage that is lower than a voltage difference between the fifth voltage and the fourth voltage to a third electrode among the third electrodes corresponding to a discharge cell to be selected among the plurality of discharge cells, while the fourth voltage is applied to a corresponding one of the first electrodes.

13. The plasma display device of claim 9, wherein during the reset period, the driving board is configured to apply a voltage waveform that gradually increases from the first voltage to a sixth voltage to the plurality of first electrodes before applying the voltage waveform that gradually decreases from the first voltage to the second voltage, and
the sixth voltage is two times as much as the first voltage.

14. The plasma display device of claim 9, wherein at the finishing point of the reset period, a voltage of the plurality of second electrodes is a sixth voltage that is lower than the third voltage,
the voltage difference between the sixth voltage and the second voltage is a voltage at which discharges are fired between the plurality of first electrodes and the plurality of second electrodes.

15. The plasma display device of claim 9, wherein the fifth voltage is a ground voltage.
